(19) United States
(12) Patent Application Publication
(10) Pub. No.: US 2025/0144666 A1
(43) Pub. Date: May 8, 2025

(54) METHODS AND SYSTEMS OF ROLL COATING

(71) Applicant: 3M INNOVATIVE PROPERTIES COMPANY, St. Paul, MN (US)

(72) Inventors: Taylor J. Kobe, Woodbury, MN (US); Shawn C. Dodds, St. Paul, MN (US); Matthew S. Stay, Bloomington, MN (US); Jonathan J. O'Hare, Woodbury, MN (US); Scott R. Culler, Burnsville, MN (US); Kristin L. Thunhorst, Stillwater, MN (US); David B. Lekander, St. Paul, MN (US); Aaron K. Nienaber, Lake Elmo, MN (US); Brian K. Daniels, Woodbury, MN (US); Andrew F. Neitzel, Menomonie, WI (US); Lucas J. Hunt, Nowthen, MN (US)

(21) Appl. No.: 18/837,336

(22) PCT Filed: Feb. 6, 2023
(86) PCT No.: PCT/IB2023/051055

§ 371 Date: Aug. 9, 2024

Related U.S. Application Data
(60) Provisional application No. 63/311,335, filed on Feb. 17, 2022.

(51) Int. Cl. B05D 1/28; B41F 9/00; B41F 9/06; B41F 13/11; B41F 19/00; B41J 2/005; B41J 2/01

(52) U.S. Cl. CPC B05D 1/28; B41F 9/003; B41F 9/063; B41F 13/11; B41F 19/001; B41J 2/0057; B41F 9/009; B41J 2002/012

(57) ABSTRACT

Methods and systems of roll coating are provided. An applicator applies a liquid material onto a receiving roll to form a liquid pattern, which is then directly or indirectly transferred onto a substrate surface under an impression force to form a continuous coating on the substrate surface.

### BACKGROUND

Gravure is a widely used method for coating where ink is metered onto an engraved or textured roll (e.g., a gravure roll) with an applicator, with any excess ink on the roll surface removed by a doctor blade. The use of a doctor blade ensures that the volume of ink transferred is proportional to the specification of the engraved pattern, such as cell depth, width, and spacing.

### SUMMARY

Briefly, in one aspect, the disclosure describes a method including applying a liquid material onto a receiving roll to form a liquid pattern. The method further includes transferring at least a portion of the liquid material in the liquid pattern either (i) from the receiving roll (as a web transfer roll) onto a major surface of a web to form a substantially continuous coating, (ii) from the receiving roll onto a web transfer roll and transferring the liquid material from the web transfer roll onto the major surface of the web to form a substantially continuous coating, or (iii) from the receiving roll onto one or more intermediate transfer rolls and then onto a web transfer roll and then transferring the liquid material from the web transfer roll onto a major surface of a web to form a substantially continuous coating. When applying the liquid material onto the receiving roll, a coating volume of the liquid material applied to the receiving roll is controlled to proportionally control a thickness for a given width of the continuous coating on the major surface of the web.

In another aspect, this disclosure describes a coating system including a receiving roll as a web transfer roll, an applicator configured to apply a liquid material onto the web transfer roll to form a liquid pattern, and a web engaging with the web transfer roll such that at least a portion of the liquid material in the liquid pattern from the web transfer roll is transferred onto a major surface of the web to form a substantially continuous coating. When applying the liquid material onto the web transfer roll, the applicator is configured to control a coating volume of the liquid material applied to the web transfer roll to proportionally control a thickness for a given width of the continuous coating on the major surface of the web.

In another aspect, this disclosure describes a coating system including a receiving roll, an applicator configured to apply a liquid material onto the receiving roll to form a liquid pattern, and a web transfer roll. Optionally, the coating system further includes one or more intermediate rolls between the receiving roll and the web transfer roll. The web transfer roll directly engages with the receiving roll, or indirectly engages with the receiving roll via the optional one or more intermediate rolls, to receive at least a portion of the liquid material from the receiving roll. A web engages with the web transfer roll such that at least a portion of the liquid material on the web transfer roll is transferred onto a major surface of the web to form a substantially continuous coating. When applying the liquid material onto the receiving roll, the applicator is configured to control a coating volume of the liquid material applied to the receiving roll to proportionally control a thickness for a given width of the continuous coating on the web transfer roll and the major surface of the web.

Various unexpected results and advantages are obtained in exemplary embodiments of the disclosure. Some advantages of exemplary embodiments of the present disclosure include: (i) the ability to vary or prescribe coating thickness by varying the volume of fluid deposited in a liquid pattern, eliminating the need for roll changes or precision engraved rolls, (ii) the ability to make ultrathin coatings that may not be reproducibly made by traditional coating methods using a gravure roll with a doctor blade for metering, and (iii) the ability to make coatings with improved uniformity over traditional gravure coating methods, in particular for extremely thin coatings where local variability in the cell engravings may significantly impact the uniformity of the coating.

Various aspects and advantages of exemplary embodiments of the disclosure have been summarized. The above Summary is not intended to describe each illustrated embodiment or every implementation of the certain exemplary embodiments of the present disclosure. The Drawings and the Detailed Description that follow more particularly exemplify certain preferred embodiments using the principles disclosed herein.

### BRIEF DESCRIPTION OF THE DRAWINGS

The disclosure may be more completely understood in consideration of the following detailed description of various embodiments of the disclosure in connection with the accompanying drawings, in which:

FIG. 1′ is a schematic diagram of a standard direct gravure system.

FIG. 1A is a schematic view of a coating system, according to one embodiment of this disclosure.

FIG. 1B is a schematic diagram of a process for printing a liquid pattern of dots via an inkjet printhead on a roll surface of FIG. 1A, according to one example.

FIG. 1C is a schematic view of the coating system of FIG. 1A to control coating thickness, according to one embodiment of this disclosure.

FIG. 1D is a schematic view of the coating system of FIG. 1A to control coating thickness, according to another embodiment of this disclosure.

FIG. 2′ is a schematic diagram of a standard offset gravure system.

FIG. 2 is a schematic view of a coating system, according to one embodiment of this disclosure.

FIG. 3 is optical microscope images of coatings under various speed ratios, according to some examples.

FIG. 4A is an optical microscope image of a coating on a substrate, according to one example.

FIG. 4B is an optical microscope image of a coating on a substrate, according to another example.

FIG. 5 is optical microscope images of a coating on polyester films, according to some examples.

In the drawings, like reference numerals indicate like elements. While the above-identified drawings, which may not be drawn to scale, sets forth various embodiments of the present disclosure, other embodiments are also contemplated, as noted in the Detailed Description. In all cases, this disclosure describes the presently disclosed disclosure by way of representation of exemplary embodiments and not by express limitations. It should be understood that numerous other modifications and embodiments can be devised by those skilled in the art, which fall within the scope and spirit of this disclosure.

### DETAILED DESCRIPTION

For the following Glossary of defined terms, these definitions shall be applied for the entire application, unless a different definition is provided in the claims or elsewhere in the specification.

### Glossary

Certain terms are used throughout the description and the claims that, while for the most part are well known, may require some explanation. It should be understood that:

In this application, the term “roll-to-roll process” refers to a process of manufacture that embeds, coats, prints, laminates, or imparts other transformative work on a flexible, rolled substrate material or materials as they are fed continuously from one roller to another.

The term “applicator” is used to refer to any appropriate means of applying a coating fluid onto a gravure roll surface. Traditional applicators in the gravure coating literature include open pans, fountain rolls, and enclosed chamber systems. In the context of this application, an applicator is capable of applying or depositing a liquid material in a pattern to a roll surface by any appropriate means, including but not limited to, for example, inkjet printing, aerosol jet printing, spray coating, flexographic printing, gravure printing, etc.

The term “inkjet printing”, “inkjet printer”, or “inkjet printhead” refers to a controlled, non-contact printing method or device that uses a jetting mechanism to expel liquid drops onto a roll surface (e.g., a piezoelectric inkjet, a continuous inkjet, a thermal inkjet, a valve-jet inkjet, etc.). Control of the printhead may be through digital or analog signals. The term “non-contact” means that there is a gap (for example, 1 mm to 2 mm) between the printhead nozzle plate surface and the roll surface. Technical advantages of inkjet printing include, for example, (i) on-demand ability to control the deposited pattern of liquid, (ii) high spatial resolution in the machine direction and cross-web direction of the deposited pattern of liquid (e.g., commercial printhead resolutions greater than or equal to 360 dots per inch), and (iii) precision low volume throughput of liquid material (e.g., commercial printhead native drop volumes 2.5 to 70 picoliters). The ability to control the liquid deposition “on-demand” means that the inkjet droplet deposition can be varied with respect to position and/or time.

The term “gravure roll” is used to refer to a roll whose outer surface contains an array of cells, purposefully produced on that surface. These cells can be engraved in any shape, size, depth, or pattern that is appropriate for applying a continuous coating onto a web, produced by any means known in the art. It is to be noted that this definition of a gravure roll includes what are commonly known as “anilox rolls” in the flexographic printing industry.

The terms “liquid,” “liquid material,” or “liquid coating material” refers to any materials flowable at coating operation conditions described herein.

The term “speed ratio” refers to the absolute value of the ratio of the surface speed of a particular roll relative to a reference speed, which may be the web speed or the speed of an adjacent roll. For example, a speed ratio of 1 means a roll speed is equal to the reference speed. A speed ratio of +0.5 or −0.5 means a roll speed is 50% faster or 50% slower, respectively, than the reference speed. When a coated roll is nipped to another roll with speed ratio other than 1, smearing of the coating may take place in the nip. It is to be understood that the speed ratio is taken as an absolute value and it is always positive. For example, when a receiving roll has a surface speed 50% slower than a second roll, the speed ratio will be 0.5 regardless of whether the two rolls have the same direction of rotation (e.g., both clockwise), or opposite directions of rotation (i.e., one clockwise, and one counterclockwise).

A “pre-metered” coating system is one in which, for a given coating width and line speed, and in the absence of coating defects, the thickness of the applied coating is determined by the amount of coating solution supplied into the system, and not by the setup of the system. For example, when using a coating die one may adjust the gap between the die and a backing roll without impacting the coating thickness, or one may adjust the flowrate of solution into the die and obtain a proportional increase in the coating thickness without adjusting the gap (so long as no coating defects are generated which may cause the system to lose pre-metering). Typical pre-metered coating systems include die coaters, curtain coaters, and slide coaters.

A “self-metering” coating system is one in which the thickness of the applied coating is determined by the physics of that system, and not by the amount of coating solution supplied into that system. For example, in a roll coating nip the coating thickness may depend on various system properties such as gap between two rolls, the hardness of any rubber coverings that are present, the viscosity of the coating fluid, etc. In such a system one may adjust the flowrate of solution into the roll coating nip without seeing any substantial change to the coating thickness, or one may adjust the gap between the two rollers and see an appreciable change in thickness without adjust the flowrate of solution supplied to the system. Typical self-metering systems include roll coaters and gravure coaters.

In this application, by using terms of orientation such as “atop”, “on”, “over,” “covering”, “uppermost”, “underlying” and the like for the location of various elements in the disclosed coated articles, we refer to the relative position of an element with respect to a horizontally disposed, upwardly-facing substrate (e.g., web). However, unless otherwise indicated, it is not intended that the substrate (e.g., web) or articles should have any particular orientation in space during or after manufacture.

In this application, the term “machine direction” or “down-web direction” refers to the direction in which the substrate or web travels. Similarly, the term “cross-web direction” refers to the direction perpendicular to the machine direction (i.e., substantially perpendicular to the direction of travel for the web), and in the plane of the top surface of the web.

In this application, the terms “about” or “approximately” with reference to a numerical value or a shape means +/−five percent of the numerical value or property or characteristic, but expressly includes the exact numerical value.

In this application, the term “substantially” with reference to a property or characteristic means that the property or characteristic is exhibited to a greater extent than the opposite of that property or characteristic is exhibited.

In this application, the singular forms “a”, “an”, and “the” include plural referents unless the content clearly dictates otherwise. As used in this specification and the appended embodiments, the term “or” is generally employed in its sense including “and/or” unless the content clearly dictates otherwise.

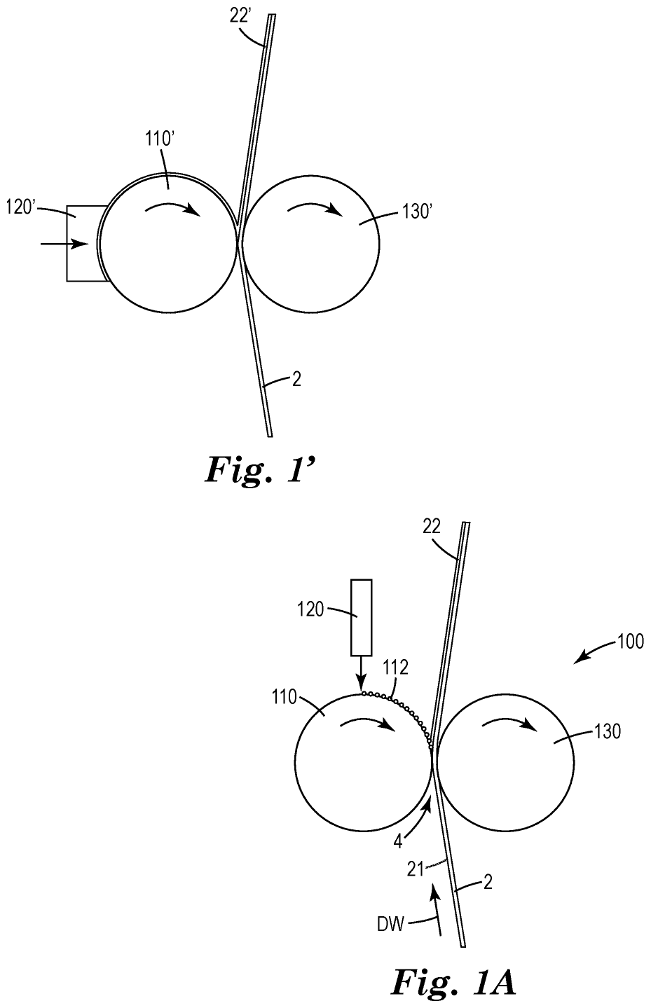

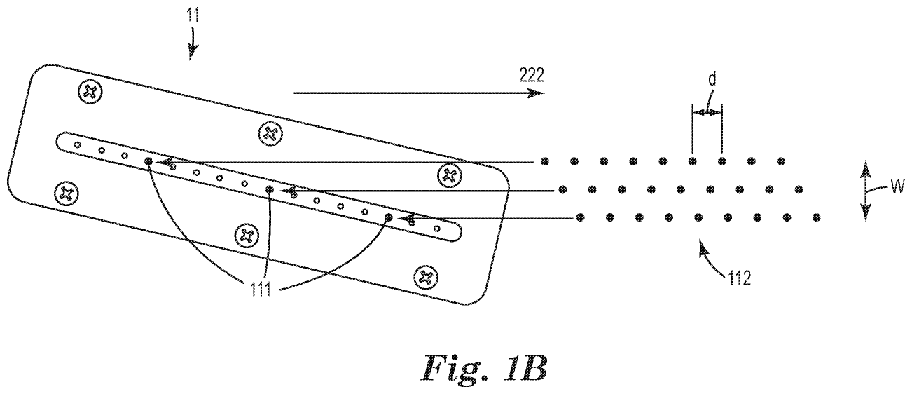

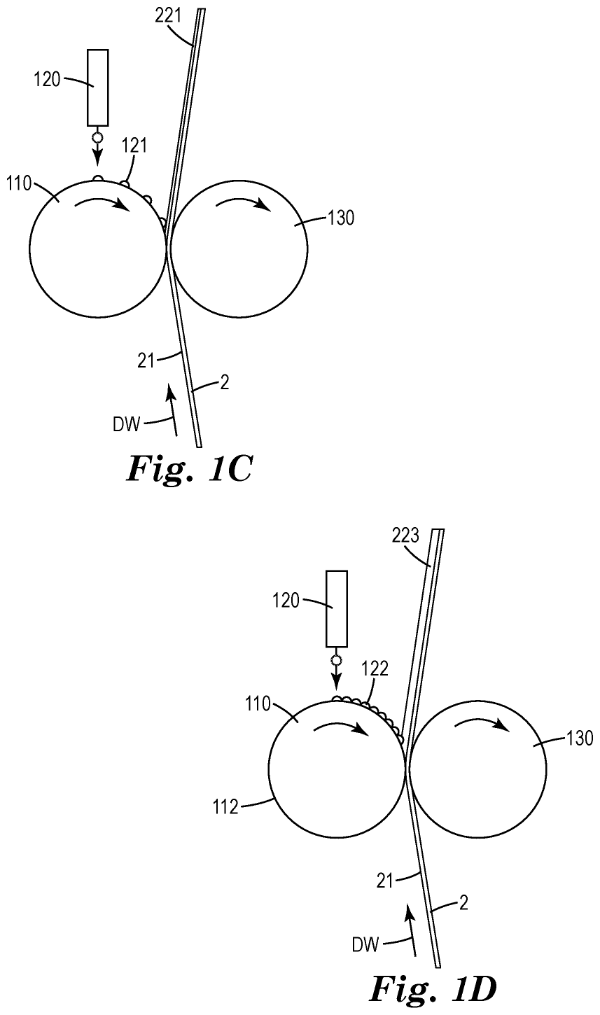

As used in this application, the recitation of numerical ranges by endpoints includes all numbers subsumed within that range (e.g., 1 to 5 includes 1, 1.5, 2, 2.75, 3, 3.8, 4, and 5). Various exemplary embodiments of the disclosure will now be described with particular reference to the Drawings. Referring to FIG. 1A, a coating system 100 is provided to form a coating 22 on a major surface 21 of a web 2. The system 100 includes a first roll 110 and a second roll 130 engaging with each other to form a nip 4. The web 2 enters the nip 4 along the machine direction or down-web direction “DW”. In the depicted embodiment of FIG. 1A, the first roll 110 is both a receiving roll and a web transfer roll. The first roll 110 is configured as a receiving roll to receive a liquid material from an applicator 120, as well as a web transfer roll to transfer the liquid material onto the major surface 21 of the web 2. The second roll 130 is a backup roll which nips against the first roll 110 to apply an impression force to press the web 2 against the first roll 110. The web 2 wraps around the backup roll 130. In some embodiments, a backup roll may not be used, and the web 2 may have a free-span that contacts to the first roll 110 with an impression force applied thereon, e.g., by the tension in the web or substrate 2.

In some embodiments, the first roll 110 may be rotating such that within the nip 4 the first roll 110 and the web 2 are travelling in the same direction (which may refer to a forward gravure configuration, or FWD), or in opposite directions (which may refer to a reverse gravure configuration, or REV). It is to be understood that the surface speed of the first roll 110 and of the web 2 may not need to have the same magnitude. In other words, there may be a speed differential between the surface speed of the first roll 110 and of the web.

The applicator 120 is positioned adjacent the first roll 110 and configured to apply a pattern of liquid material onto the first roll 110 when the first roll 110 rotates at a predetermined speed. In some embodiments, the applicator 120 includes an inkjet printer which allows a user to control a print pattern from a digital interface, e.g., making changes on-demand. The liquid pattern may include at least one of a regular or irregular pattern of dots, discontinuous lines, grids, or geometric shapes. In some embodiments, the pattern of liquid material can be conveniently present in the form of discrete quantities such as droplets including dots, short intermittent stripes, or any other appropriate shapes. In some embodiments, the liquid material in the liquid pattern 112 applied to the first roll 110 is discontinuous in at least one of the cross-web direction and the down-web direction. In some embodiments, the liquid pattern is discontinuous in both cross-web direction and down-web direction. In other words, at least some of the discrete quantities are disconnected with respect to each other with a gap between nearest neighbors in either or both machine direction and cross-web direction. In some embodiments, the gap may be, for example, no less than 1 time, no less than 2 times, no less than 5 times, or no less than 10 times the average lateral size of the discrete quantities (e.g., an average diameter of dots). In some embodiments, some of the droplets may slightly overlap with the nearest neighbors. It is to be understood that the inkjet printer 120 can be other suitable applicators. In general, any suitable applicators that can provide the liquid material onto a receiving roll in a liquid pattern can be used.

In the depicted embodiment of FIG. 1A, the applicator 120 is an inkjet printer. FIG. 1B illustrates the arrangement of nozzles 111 on a printer head 11 of the inkjet printer 120 of FIG. 1A, and the corresponding printed pattern 112 of liquid material on the first roll 110, according to one example. The printed pattern 112 extends along the down-web direction (“DW”) direction 222 with a width “W”.

In some examples, the printer 120 may include inkjet printheads which can deliver various droplet patterns to precisely control ink volumes. Exemplary printheads may include a piezoelectric inkjet printhead. Native drop volume may also be controlled by printhead selection. For example, piezoelectric inkjet printheads are commonly manufactured in small, medium, and large size corresponding to native drop volumes, which ranges from 2.4 to 70 picoliters or more. In some examples, the printer 120 may digitally control the volume of each droplet by in-flight (i.e., grey-scale printing) or on-impact coalescence of subsequent drops in a range, for example, from about 2.4 picoliter to about 1.0 microliter. In some examples, the printed pattern of liquid material is present in the form of discrete droplets each having an in-plane substantially round shape and a cross-sectional dome shape. The printed droplet diameter and droplet height may depend on the liquid volume and contact angle. A theoretical contact angle of a droplet on a roll surface may be greater than 5 degrees, greater than 10 degrees, greater than 20 degrees, or greater than 30 degrees. In some examples, a droplet may have a diameter greater than 20 micrometers, greater than 30 micrometers, greater than 40 micrometers, greater than 50 micrometers, or greater than 100 micrometers. The pattern of the droplets can be adjusted in the cross-web direction (“CW”) by arranging the nozzles 112 on the printer head 11 to adjust the cross-web nozzle spacing. The pattern of the droplets can be further adjusted in the machine direction (“DW”) by changing the firing frequency of the nozzles. The pattern of droplets can be adjusted in both the cross-web and machine directions by the print pattern itself, for instance, by selectively activating or deactivating nozzles. It is to be understood that, in some embodiments, the printed quantities of liquid material may be present as other shapes such as, for example, short intermittent stripes, squares, grids, etc. It is also to be understood that direct inkjet printing from the printer 120 onto a substrate or web may not be capable of achieving continuous ultrathin solvent-free coatings, even at the highest resolution and smallest drop volumes.

The liquid material can include any coatable material including, for example, water-based or solvent-based solutions, thermally curable solutions, radiation curable solutions, primers, adhesives, release materials, oils, waxes, hard coats, optical coatings, inks, dispersions, emulsions, combinations of any of these examples, etc. In some examples, a liquid material may include an inkjet-compatible liquid material where the ability to control spatial deposition is maintained. In some examples, a liquid material may include typical fluids for generating, for example, a pattern of droplets. Liquid materials of interest may be those with desirable properties for use as release liners or materials, low-adhesion backsize coatings, hardcoats, primers, optical coatings, adhesive coatings, etc.

Optimal properties for the liquid material may depend on the particular application method used to produce the desired pattern on a receiving roll. For example, when the pattern is produced via inkjet printing, the liquid material may have a viscosity below about 100 centipoise (cP), optionally between about 10 and 15 cP. For example, when the pattern is produced via flexographic printing, the liquid material may have a viscosity below about 10,000 cP, optionally between about 500 and 2,000 cP. The liquid material may be Newtonian or non-Newtonian, shear thinning or shear thickening, so long as it is able to produce the desired pattern. In some embodiments, the liquid material may have a surface tension below about 100 mN/m, preferably between 20 mN/m and 40 mN/m. In some embodiments, temperature may be employed to adjust the viscosity and/or surface tension of a material so that it is more readily patterned. For example, an ink may have a viscosity that is too high at room temperature, but that decreases to a range that is acceptable for printing at an elevated temperature. Physical properties of the liquid material, such as viscosity, surface tension, and density, are not meant to be limiting so long as the desired pattern can be achieved on a receiving roll via an applicator (e.g., an inkjet printer).

The web material may be any substrate capable of roll-to-roll web handling. In some embodiments, exemplary substrates may include but are not limited to thermoplastics such as polyesters (e.g., polyethylene terephthalate or polyethylene naphthalates), polyacrylates (e.g., polymethyl methacrylate or “PMMA”), poly(vinyl acetate) (“PVAC”), poly(vinylbutyral) (“PVB)”, poly(ethyl acrylate) (“PEA”), poly(diphenoxyphosphazene) (“PDPP”), polycarbonate (“PC”), polypropylene (“PP”), high density polyethylene (“HDPE”), low density polyethylene (“LDPE”), polysulfone (“PS”), polyether sulfone (“PES”), polyurethane (“PUR”), polyamide (“PA”), polyvinyl chloride (“PVC”), polyvinylidene fluoride (“PVdF”), polystyrene and polyethylene sulfide; and thermoset plastics such as cellulosic derivatives, polyimide, polyimide benzoxazole, polybenzoxazole, crosslinked acrylates, polyepoxide resins, and polydimethylsiloxane resins. Other suitable substrates may include papers such as cellulosic or synthetic paper, nonwoven, metal foil, glass, foam, etc. It should be understood that any suitable substrate may optionally be coated or treated by one or more coatings or treatments. It should also be understood that when the major surface 21 of web 2 includes interruptions (e.g., depressions, apertures, etc.), a substantially continuous liquid coating may form on the portions of the major surface 21 that come into contact with the first roll 110 as it passes through the impression nip 4. Conversely, the interruptions may not be directly coated with a liquid layer as it passes through the impression nip 4.

In some embodiments, useful substrates are typically in the form of a film. Depending on the method or methods used in making the film, the film may be smooth or may be structured on its major surface. Methods for making suitable smooth film substrates are well known in the art and include, for example, cast film extrusion and/or blown film extrusion. One example of a substrate having a structure is a “microreplicated” film. Methods for making microreplicated films are well known in the art and include, for example, continuous cast and cure processes. In one embodiment, a substrate may have a thickness value in the range from about one micrometer to about 25,000 micrometers. In another embodiment, the substrate film may have a thickness value in the range from about 12 micrometers to about 10,000 micrometers. In still another embodiment, the substrate film may have a thickness value in the range from about 50 micrometers to about 2000 micrometers.

In some embodiments, the major surface 21 of the web 2 may be interrupted by one or more structural features (e.g., depressions, apertures, etc.) that do not directly receive the transferred coating. A structured surface of a substrate may be a microstructured surface formed by an extrusion replication procedure utilizing a tool that imparts a negative structure in the polymer surface. The tooling can be in any of a variety of forms and materials. Typically, the tooling is a sheet, roll, belt, or roll of surface structured film made of metal or polymer. For metal tools, the metal is generally diamond-machined, embossed, knurled, sandblasted, etc. to form the surface structure. The structured polymer surface is generally formed by extrusion replication where a thermoplastic resin such as a fluoropolymer extruded through a die and into a nip with a machined metal tool roll and a rubber roll.

The molten polymer is quenched while in contact with the tool surface which then releases from the tool roll and is wound on a roll. Another technique for making structured surfaces is to coat UV curable acrylate functional resins against a tool followed by removal of the cross-linked structured film from the tool. Yet another technique for making structured surfaces is to coat thermally curable urethane functional resins against a tool followed by removal of the cross-linked structured film from the tool. This polyurethane layer can be prepared from the condensation polymerization of a reaction mixture that includes a polyol, a polyisocyanate, and a catalyst.

In some embodiments, the first roll 110 may be a gravure roll, which refers to a roll that has an array of microwells (also called cells) used to carry the liquid material. The cells may be created by any suitable techniques or methods, such as mechanical engraving, laser engraving, or etching, which are well known in the industry. A gravure roll typically may have a rigid surface. The cells may have any suitable size, including cell depths ranging from 1 micrometer or less to greater than 100 micrometers, or cell widths ranging from 10 micrometers or less to greater than 500 micrometers. The cells may have any suitable centre-to-centre spacing, ranging from 100 cells per inch or less to greater than 2000 cells per inch. The cells may also have any suitable shape or arrangement, such as hexagonal, quadrangular, or trihelical. The size, shape, and arrangement of the cells defines the capacity for the roll to carry fluid, and is typically specified as the volume factor of the roll, given in units of BCM/in² (Billion Cubic Microns per square inch). The volume factor of a roll is a geometrical parameter that is determined at the time of engraving.

In some embodiments, the first roll 110 may not include a pattern of cells. Instead, the first roll 110 may contain a random surface structure with peaks and valleys. Such random surface structures on a roll may be fabricated using any suitable method, and may be characterized by any suitable metric, such as an arithmetic mean roughness (commonly referred to as Ra), and root mean squared roughness (commonly referred to as Rq), an average maximum peak to valley within five sampling lengths (commonly referred to as Rz), parameters based on material ratio curves (common examples include Rk, Rpk, Rmr, tp, Rmr1, Rvk, Rmr2), parameters based on probability models such as plateau root mean squared roughness (commonly referred to as Rpq), valley root mean squared roughness (commonly referred to as Rvq), and plateau-valley transition bearing ratio (commonly referred to as Rmq), and other suitable metrics for quantifying surface finish. Typical values for Ra may be, for example, about 1,000 nm or less, about 500 nm or less, about 100 nm or less, or about 50 nm or less. A volume factor for such a roll may still be defined by the volume per unit area of liquid that can be carried between the peaks and valleys on the surface of the roll. An example of a random surface structure is an abraded, honed, or plateau honed surface.

Referring again to FIG. 1A, when the web 2 engages with the first roll 110, the liquid material in the pattern 112 on the first roll 110 is at least partially transferred from the first roll 110 to the major surface 21 of the web 2 and smears into a substantially continuous coating 22 on a portion of the web surface 21 which has a substantially smooth surface. A span or a portion of the web surface 21 is substantially smooth when it is absent of interruptions that may prevent the formation of a continuous coating. Such interruptions may include recessed or raised features having a depth/height dimension significantly greater than the coating thickness. The substantially continuous coating 22 has a thickness in a range, for example, from 5 nm to 500 micrometers, from 10 nm to 200 micrometers, from 10 nm to 100 micrometers, from 10 nm to 10 micrometers, or from 10 nm to 5 micrometers.

In some examples, the coating thickness and uniformity of the coating 22 on the web surface 21 can be controlled by controlling the pattern of liquid material on the first roll 110. For example, as shown in FIG. 1B, the spacing d between the adjacent droplets can be decreased to increase the total volume of fluid deposited in a section of the first roll 110, which in turn will increase the coating thickness of the smoothed coating on the web 2, without changing the volume of the droplets themselves. For example, as shown in FIG. 1C, when a system generates 10 pL droplets in a square grid 121 with a 250-micrometer center-to-center spacing, this corresponds to a total volume of 160 pL/mm², or 160-nm equivalent thickness of the continuous coating 221 on the major surface 21 of the web 2. As shown in FIG. 1D, when the same 10 pL drop is spaced on a square grid 122 with a 125-micrometer separation, this corresponds to a total volume of 640 pL/mm², or an equivalent thickness of 640 nm of the continuous coating 223 on the web 2. In this manner, the equivalent coating thickness is quadrupled without changing the volume of each droplet.

In some embodiments, the use of an inkjet printer may allow the position of the droplets to be changed dynamically, allowing an operator to adjust the down-web and/or cross-web coating thickness profile to meet any desired criteria (e.g., to improve the uniformity, to purposefully introduce coating thickness variations, etc.) without stopping the machine. In some embodiments, the use of an inkjet printer may allow the volume of the droplets to be changed dynamically, allowing an operator to adjust the down-web and/or cross-web coating thickness profile to meet any desired criteria.

In a traditional gravure coating system, while the thickness of the coating can be primarily determined by the specifications of the engraving on the gravure roll, in some cases the coating thickness and uniformity may be additionally adjusted by controlling the ratio of the surface speed of the gravure roll to the speed of the web (or, in the case of transfer coating, to the surface speed of the transfer roll). This can be understood by noting that while the BCM sets the volume of coating solution carried into the nip by each cell, when the gravure roll speed is increased relative to the substrate speed, the number of cells carried into the nip per unit length of substrate may increase, resulting in a larger flowrate of liquid into the coating nip, and thus a thicker coating on the substrate. It is to be understood that this may not be a linear effect, as the pickout (which is commonly defined as the percentage of the coating solution that is transferred from a given gravure cell to the web) may depend on roll speed ratio. This coupling makes the impact of roll speed ratio on coating thickness difficult to understand, as well as system dependent. For example, one may modify the viscosity of the coating solution or the geometry of the gravure cells and observe a substantial change in the pickout, resulting in substantially different coating thickness and/or a change in the way thickness varies as a function or roll speed ratio.

One benefit of some embodiments in this disclosure is that, by using an inkjet printer to vary the amount of coating solution applied on a gravure roll, the coating thickness can be directly controlled and adjusted. In other words, the coating system in some embodiments of this disclosure may be described as a pre-metered system in that changes to the amount of fluid supplied onto the gravure roll result in clear and predictable changes to the thickness of the coating on the web. To explain this benefit, it is helpful to note that it is known in the literature that a roll coating nip has a maximum flowrate of liquid allowed through for a given condition (for an explanation of this effect, see Coyle, Macosko, and Scriven, 1986, “Film-Splitting Flows in Forward Roll Coating”, Journal of Fluid Mechanics, vol. 171, pp. 183-207), and supplying fluid in excess of this critical value has very little impact on the resulting coating thickness. This in turn implies that this excess fluid is rejected by the roll coating nip, most typically via what is known as a rolling bank. The rejection of fluid and the configuration-dependent flowrate are why a roll coating nip is commonly referred to as self-metering. Further evidence of the self-metering nature of roll coaters is that they are most commonly operated using a pan or some other system to supply a large excess of fluid to the roll nip, with much of that excess rejected by the nip. In contrast, when the flowrate of liquid entering the nip is kept below this critical value, it is possible to pre-meter the nip, enabling the coating operator to make predictable changes in the coating thickness. What is particularly surprising is that some embodiments of this disclosure can achieve a pre-metered and continuous coating with a pattern of liquid material, without any substantial levelling or merging of the pattern prior to the point where the liquid material is transferred. Although one might expect a priori that any condition that operates in a starved mode would be incapable of sufficiently spreading a pattern of liquid droplets into a continuous layer without losing pre-metering, it is shown in some examples that the equivalent volume of the input layer can be varied by an order of magnitude without losing the pre-metering capability.

In some examples, the coating thickness and uniformity of the coating 22 on the web 2 can be controlled by controlling the surface roughness of the first roll 110. For example, a polished roll surface with a random roughness may improve drop spreading on the web when the web 2 engage with the first roll 110 under an impression force, as compared to a gravure roll surface with a well-defined cell structure engraving.

In some examples, the coating thickness and uniformity of the coating 22 on the web 2 can be controlled by controlling an impression force between the first roll 110 and the web 2. For example, the nip engagement can be adjusted such that a coating changes from discontinuous to continuous.

FIG. 1′ is a schematic diagram of a standard gravure coating system 100′. Applicator 120′ applies liquid material (e.g., ink) onto the gravure roll 110′. The gravure roll 110′ has a textured surface, e.g., an array of microwells (also called cells) used to carry the liquid material. The cells can be produced with various shapes by any suitable techniques or methods, all of which are well known in the coating and printing industries. The volume and pattern of the liquid material is regulated by the location and characteristic of the recessed roughness of the roll surface as a doctor blade (not shown) wipes and removes any excess liquid material proud to the roll surface.

For gravure coating using the system 100′ of FIG. 1′, the gravure roll 110′ is pressed against a backup roll 130′ with the web 2 nipped between the gravure roll 110′ and the backup roll 130′. Some fraction of liquid material is transferred from the gravure roll 110′ to the web 2, with the amount of fluid transferred set by the pickout (defined above). The standard gravure coating system 100′ requires a standard metering system, e.g., an applicator and a doctor blade, to control the volume of liquid material applied onto the gravure roll 110′. In contrast, some embodiments of coating systems and methods described herein do not require such a standard metering system. Instead, some embodiments described herein use a printer such as, for example, an inkjet printer, which is capable of precisely and consistently depositing a pattern of liquid material on a roll surface.

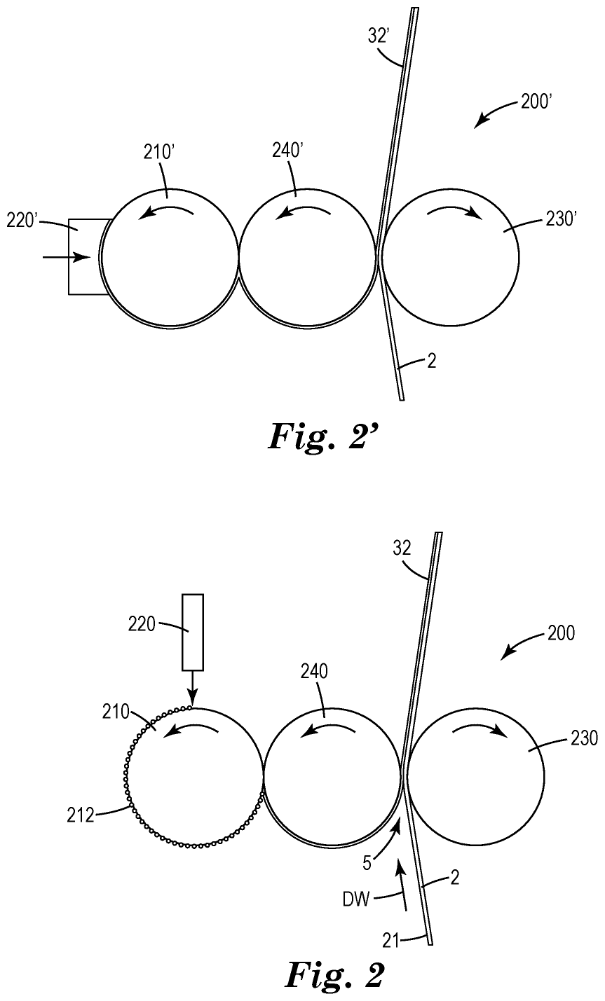

During a traditional coating operation such as shown in FIG. 1′ or FIG. 2′ (to be described further below), a gravure roll is supplied with an excess of coating solution by any one of several means known in the art (e.g., pans, enclosed chambers, etc.), and any excess solution is scraped off by a doctor blade. Assuming ideal blading, where the liquid fills the cells without any excess, this ensures that the amount of liquid carried into the coating nip is equal to the volume factor of the roll. The use of a doctor blade ensures that the volume of ink transferred is proportional to the specification of the engraved pattern, such as cell depth, width, and spacing. However, this means that any variability in the engraved pattern will result in variability in the thickness of the applied coating, which may not be desirable. This is particularly relevant for thin coatings, where a gravure roll may need to have very shallow/narrow cells that are difficult to engrave if the roll is to have an acceptably low volume factor. Additionally, adjusting the coating thickness often requires that a new gravure roll be used, as the volume of the cells on the roll cannot be adjusted on the fly.

There are several primary drawbacks to the approach as shown in FIG. 1′ or FIG. 2′. First, if an operator wishes to adjust the amount of coating solution supplied, they have very few options available, and often end up needing to change the gravure roll. In addition, because the volume of the liquid carried into the coating nip depends primarily on the volume of the cells, local variations in the cell engraving will lead to local variations in the volume factor, which in turn translate to variations in coating thickness. Furthermore, the use of a doctor blade, which is stationary, can trap particles and generate streaks. A benefit of some embodiments in this disclosure is that by metering the liquid material onto the surface of the gravure roll and at least partially transferring that liquid onto the substrate (either directly or indirectly via a transfer roll), without the use of a doctor blade, the thickness of the applied coating can be dynamically adjusted while using the same gravure roll, which isolates the impact of any variability in the engraving on the coating thickness, and eliminates streaks induced by the doctor blade, allowing us to use an “imperfect” roll to produce a uniform coating.

Referring to FIG. 2, a coating system 200 is provided to form a coating on a web 2. The system 200 includes a receiving roll 210 and a web transfer roll 240 engaging with each other. A backup roll 230 is positioned to press against the web transfer roll 240. The web 2 enters the nip 5 along the machine direction or down-web direction “DW”. In the depicted embodiment of FIG. 2, the backup roll 230 nips against the web transfer roll 240 to apply an impression force to press the web 2 against the web transfer roll 240. The web 2 wraps around the backup roll 230. In some embodiments, a backup roll may not be used, and the web 2 may have a free-span contact to the web transfer roll 240 (this may be referred to as a kiss configuration, or a tensioned-web configuration).

An applicator 220 is positioned adjacent the receiving roll 210 and configured to apply a pattern of liquid material onto the receiving roll 210 when the receiving roll 210 rotates at a predetermined speed. In the depicted embodiment of FIG. 2, the applicator 220 is similar to the applicator 120 of FIG. 1, and can be a printer such as an inkjet printer. It is to be understood that the applicator 220 can be other suitable applicators. In general, any suitable applicators that can provide the liquid material onto the first roll in a liquid pattern can be used.

In some embodiments, the pattern of liquid material can be conveniently present in the form of discrete quantities such as droplets including dots, short intermittent stripes, or any other shapes. At least some of the discrete quantities are disconnected with respect to each other with a gap between nearest neighbors in either or both machine direction and cross-web directions. In some embodiments, the gap may be, for example, no less than 1 time, no less than 2 times, no less than 5 times, or no less than 10 times the average lateral size of the discrete quantities (e.g., an average diameter of dots). In some embodiments, some of the droplets may slightly overlap with the nearest neighbors.

In some embodiments, the receiving roll 210 may be a gravure roll, which refers to a roll that has an array of microwells (also called cells) used to carry the liquid material. The cells can be produced with various shapes by any suitable techniques or methods, all of which are well known in the coating and printing industries. It is to be understood that in some embodiments, the receiving roll 210 may be the same as the first roll 110 of FIG. 1A.

In the depicted embodiment of FIG. 2, the receiving roll 210 is configured to receive a liquid material from the applicator 220. The web transfer roll 240 is used as an intermediate between the web 2 and the receiving roll 210. In some embodiments, the web transfer roll 240 is provided to prevent the receiving roll 210 (e.g., a gravure roll) from damaging a sensitive substrate, or to allow for thinner coatings by running the web transfer roll at a significantly faster surface speed than the receiving roll 210. An appropriate web transfer roll is any roll that can create a nip with and receive coating solution from the web transfer roll 240, and separately create a nip with the backup roll and transfer coating to the substrate (or in the case of free-span coating, simply transfer the coating to the web in the absence of the backup roll). Examples of suitable transfer rolls may include rigid metal rolls and metal rolls with deformable outer coverings. Suitable deformable outer coverings may include materials such as urethanes, silicones, nitrile rubbers, natural rubbers, EPDM rubbers, photopolymers, etc., or any combination thereof. A deformable outer cover may have a single layer of deformable material, or may have multiple layers of deformable material. When there are multiple layers, each layer may be composed of a different material, for example in a three-layer outer cover there may be one layer composed of an EPDM rubber, one layer composed of a urethane rubber, and one layer composed of a silicone rubber. While we do not place any limitations on the ratio of speeds between the backup roll and transfer roll, or between the web transfer roll and gravure roll, it might be typical to run a speed ratio of 0.9 to 1.1 between the web transfer roll and the backup roll, and a ratio of 0.1 to 3 between the web transfer roll and the receiving roll.

Referring again to FIG. 2, when the web 2 engages with the web transfer roll 240 the liquid material in a liquid pattern 212 on the receiving roll 210 is at least partially transferred from the receiving roll 210 to the web transfer roll 240. Under the nipping pressure, the pattern of liquid material may smear into a more continuous pattern onto the web transfer roll 240. In some examples, the adjacent droplets may at least partially connect with each other. At least a portion of the liquid material on the web transfer roll 240 is then transferred to the web 2, smearing into a substantially continuous coating 32 on a major surface 21 of the web 2 where the web 2 has a substantially smooth surface. The substantially continuous coating 32 has a thickness in a range, for example, from 5 nm to 500 micrometers, from 10 nm to 200 micrometers, or from 10 nm to 100 micrometers.

In various examples, the coating thickness and uniformity on a web surface can be controlled by controlling a roll speed ratio. For example, in the case of a two-roll system such as the system 100 of FIG. 1A, the ratio of the absolute value of the surface speed of the gravure roll to the web speed can be adjusted to range from 0.1 to 5, 0.1 to 2, 0.5 to 2, or 0.75 to 1.25. It is to be understood that because this ratio is defined as an absolute value, it does not depend on the direction of rotation of either roll. Indeed, the gravure roll can rotate either with or against (i.e., either forward or reverse relative to) the direction of motion of the web and, if included, a backup roll. In the case of a three-roll coating setup such as the system 200 of FIG. 2, there may be a speed ratio defined by the absolute value of the surface speed of the web transfer roll relative to the speed of the web (the web transfer roll speed ratio) as well as a speed ratio defined by the absolute value of the surface speed of the gravure roll relative to the speed of the web. It is to be understood that we place no limitation on the direction of rotation of any one roll relative to any other roll (i.e., any nip may be able to operate in either forward or reverse modes). It is to be understood that while FIGS. 1A, 1C, 1D, and 2 show reverse nips between adjacent rolls, we allow for adjacent rolls to rotate in the opposite direction as well. In some embodiments it may be advantageous to choose one direction of roll rotation over another. For example, in some embodiments that include a three-roll configuration (e.g., a receiving roll, a web transfer roll, and a backup roll), it may be preferred to run a receiving roll in reverse relative to a web transfer roll to achieve improved coating quality, and to run the transfer roll in forward relative to the backup roll to avoid web tension upsets. In some embodiments, it may be advantageous to choose one roll speed ratio over another. Typical values for the web transfer roll speed ratio may be 0.5 to 1.5, 0.75 to 1.25, or 0.9 to 1.1, while typical values for the gravure roll speed ratio may be 0.1 to 5, 0.1 to 2, 0.5 to 2, or 0.75 to 1.25. While the above discussion has focused on the case of either two-roll or three-roll systems, it is to be understood that in place of a single transfer roll one may use multiple transfer rolls or intermediate rolls. For example, one may have a five-roll coating setup which includes a receiving roll, two intermediate roll, a web transfer roll, and a backup roll. In some embodiments, one or more optional intermediate rolls can be provided between the receiving roll and the web transfer roll. For example, in a variant of the embodiment depicted in FIG. 2, one or more intermediate rolls can be provided between the receiving roll 210 and the web transfer roll 240. The liquid material in the liquid pattern can be first transferred from the receiving roll onto the one or more intermediate rolls, and then be transferred from the intermediate roll(s) onto the web transfer roll 240. The liquid material is then transferred from the web transfer roll 240 onto a major surface of a web to form a substantially continuous coating.

In some examples, the coating thickness and uniformity of the coating 32 on the web surface can be controlled by controlling the surface roughness of the receiving roll 210 and the surface roughness of the web transfer roll 240. For example, a polished roll surface with a random roughness may improve drop spreading on the web when the web 2 engage with the web transfer roll 240 under an impression force. While it is common in the roll coating space for the impression force between two rolls in a nip to be adjusted as a means of tuning the coating thickness, in some embodiments of this disclosure the impression force at any nip within the coater may not significantly impact the coating thickness. Typical means of adjusting the impression force may include either controlling the force directly between the two rolls (for example, using air cylinders to engage one roll into the other), or controlling the position of one roll relative to the other (for example, using a leadscrew, or pressing the roll with a high force against a set of stops, with adjustment of the stops used to precisely control the roll(s) relative position to each other or the substrate). In either case, the impression force may be conveniently quantified by the footprint, which is a measure of the machine direction length over which the two rolls are in contact. Typical values for the footprint may be less than 1 mm, less than 3 mm, less than 5 mm, less than 10 mm, or less than 15 mm, with a preferred value less than 5 mm. In some embodiments a larger footprint may improve spreading of adjacent droplets, assisting the formation of a uniform and continuous coating, though it is usually desirable to run the smallest footprint possible.

FIG. 2′ is a schematic diagram of a standard gravure coating system 200′. Applicator 220′ applies liquid material (e.g., ink) onto the gravure roll 210′. Similar to the gravure roll 110′, the gravure roll 210′ has a textured surface, e.g., an array of microwells (also called cells) used to carry the liquid material. The volume and pattern of the liquid material is regulated by the location and characteristic of the recessed roughness of the roll surface as a doctor blade (not shown) wipes and removes any excess liquid material proud to the roll surface.

For gravure coating using the system 200′ of FIG. 2′, the gravure roll 210′ is nipped against a transfer roll 240′. The web transfer roll 240′ engages with a backup roll 230′ with the web 2 nipped between the web transfer roll 240′ and the backup roll 230′. Liquid material is at least partially transferred from the gravure roll 210′ to the web transfer roll 240′, and subsequently at least partially transferred from the web transfer roll 240′ to the web 2. Similar to the standard gravure coating system 100′, the offset gravure coating system of 200′ requires a standard metering system, e.g., an applicator 220′ and a doctor blade (not shown), to control the volume of liquid material applied onto the gravure roll 210′. In contrast, some embodiments of the coating systems and methods described herein do not require such a standard metering system. Instead, some embodiments described herein use a printer such as, for example, an inkjet printer, which is capable of precisely and consistently depositing a pattern of liquid material on a roll surface.

In the gravure coating configuration shown in FIG. 1′ and the offset gravure coating configuration shown in FIG. 2′, the thickness of the transferred solution onto a substrate is determined primarily by the volume of the solution metered onto the gravure roll. The volume of solution metered is a function of the gravure roll surface engraving or texturing, e.g., the volumes of cells on the roll surface. In other words, the minimum wet coating thickness achievable with gravure may be limited by the inability to robustly manufacture gravure rolls with smaller and smaller cells. For example, a traditional gravure coater may not be able to apply coatings with a thickness less than one micrometer, less than 0.5 micrometers, or even less than 0.1 micrometers. While inkjet printing may not be capable of directly achieving such thin, continuous coatings, by utilizing a printer to generate a pattern of drops in combination with a roll nip to distribute the volume of those drops over a larger area, we are able to produce coating thicknesses below a value achievable with either method used on its own, for example less than 10 micrometers, less than 5 micrometers, less than 2 micrometers, less than one micrometer, less than 0.5 micrometers, or less than 0.1 micrometers. For example, a high-resolution piezoelectric inkjet printhead can precisely deliver a pattern of liquid material onto a gravure roll, which allows a discontinuous drop pattern (e.g., with gaps between the adjacent individual drops) with certain drop heights to be applied onto a roll surface, which is then at least partially transferred onto a web to form a substantially continuous coating with a thickness less than the drop height.

Some embodiments of the present disclosure use an inkjet printer instead of a standard applicator in gravure coating, which eliminates the need to manufacture gravure rolls with very precise cell structures, in particular as it pertains to shallow/narrow cells that are difficult to engrave accurately using existing technology. An inkjet printer enables precision metering to ultra-low coating volumes not achievable with typical gravure roll machining. An inkjet printer also enables digital control of the coating volume as well as the coating pattern.

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the specification and more particularly the Listing of Exemplary Embodiments and the claims can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

Exemplary embodiments of the present disclosure may take on various modifications and alterations without departing from the spirit and scope of the present disclosure. Accordingly, it is to be understood that the embodiments of the present disclosure are not to be limited to the following described exemplary embodiments, but are to be controlled by the limitations set forth in the claims and any equivalents thereof.

### Listing of Exemplary Embodiments

Exemplary embodiments are listed below. It is to be understood that any one of the embodiments 1-15, 16-20, 21-23, and 24-26 can be combined.

Embodiment 1 is a method comprising:
applying a liquid material onto a receiving roll to form a liquid pattern; and
transferring at least a portion of the liquid material in the liquid pattern either
   (i) from the receiving roll onto a major surface of a web to form a substantially continuous coating, wherein the receiving roll is a web transfer roll;
   (ii) from the receiving roll onto a web transfer roll and transferring the liquid material from the web transfer roll onto the major surface of the web to form a substantially continuous coating; or
   (iii) from the receiving roll onto one or more intermediate transfer rolls and then onto a web transfer roll and then transferring the liquid material from the web transfer roll onto the major surface of the web to form a substantially continuous coating,
wherein when applying the liquid material onto the receiving roll, a coating volume of the liquid material applied to the receiving roll is controlled to proportionally control a thickness for a given width of the continuous coating on the major surface of the web.

Embodiment 2 is the method of embodiment 1, further comprising forming a nip between the web and the web transfer roll.

Embodiment 3 is the method of embodiment 1 or 2, further comprising applying an impression force to press the web to engage with the web transfer roll.

Embodiment 4 is the method of embodiment 3, wherein applying the impression force further comprises pressing the web via a backup roll, or wrapping a free span of the web around the web transfer roll.

Embodiment 5 is the method of any one of embodiments 1-4, further comprising controlling the coating volume of the liquid material applied to the receiving roll such that the continuous coating has a coating thickness in a range from 10 nm to 100 micrometers.

Embodiment 6 is the method of embodiment 5, wherein controlling the coating volume of the liquid material further comprises controlling the liquid pattern on the receiving roll.

Embodiment 7 is the method of any one of embodiments 1-6, wherein applying the liquid material onto the receiving roll further comprises inkjet printing the liquid material to form the liquid pattern.

Embodiment 8 is the method of any one of embodiments 1-7, wherein the liquid pattern comprises at least one of a regular or irregular pattern of dots, discontinuous lines, grids, or geometric shapes.

Embodiment 9 is the method of any one of embodiments 1-8, wherein the liquid material in the liquid pattern is discontinuous in at least one of a cross-web direction and a down-web direction.

Embodiment 10 is the method of any one of embodiments 1-9, wherein applying the liquid material onto the receiving roll further comprises at least one of flexographic printing, or gravure printing.

Embodiment 11 is the method of any one of embodiments 1-10, further comprising controlling a uniformity of the continuous coating when transferring the liquid material from the web transfer roll onto the major surface of the web.

Embodiment 12 is the method of embodiment 11, further comprising controlling the liquid pattern of the liquid material applied to the receiving roll to control the uniformity.

Embodiment 13 is the method of embodiment 11 or 12, further comprising controlling a roll speed ratio to control the uniformity.

Embodiment 14 is the method of any one of embodiments 11-13, further comprising controlling a surface roughness of the receiving roll to control the uniformity.

Embodiment 15 is the method of any one of embodiments 11-14, further comprising controlling an impression force of the web transfer roll and the web to control the uniformity.

Embodiment 16 is a coating system comprising:
a receiving roll, wherein the receiving roll is a web transfer roll;
an applicator configured to apply a liquid material onto the web transfer roll to form a liquid pattern; and
a web engaging with the web transfer roll such that at least a portion of the liquid material in the liquid pattern from the web transfer roll is transferred onto a major surface of the web to form a substantially continuous coating,
wherein when applying the liquid material onto the web transfer roll, the applicator is configured to control a coating volume of the liquid material applied to the web transfer roll to proportionally control a thickness for a given width of the continuous coating on the major surface of the web.

Embodiment 17 is a coating system comprising:
a receiving roll;
an applicator configured to apply a liquid material onto the receiving roll to form a liquid pattern;
a web transfer roll, and optionally, one or more intermediate rolls between the receiving roll and the web transfer roll, wherein the web transfer roll directly engages with the receiving roll, or indirectly engages with the receiving roll via the optional one or more intermediate rolls, to receive at least a portion of the liquid material from the receiving roll; and
a web engaging with the web transfer roll such that at least a portion of the liquid material on the web transfer roll is transferred onto a major surface of the web to form a substantially continuous coating,
wherein when applying the liquid material onto the receiving roll, the applicator is configured to control a coating volume of the liquid material applied to the receiving roll to proportionally control a thickness for a given width of the continuous coating on the web transfer roll and the major surface of the web.

Embodiment 18 is the system of embodiment 16 or 17, further comprising a backup roll to press the web to engage with the web transfer roll.

Embodiment 19 is the system of any one of embodiments 16-18, wherein the applicator includes an inkjet printer.

Embodiment 20 is the system of any one of embodiments 16-19, wherein the applicator is configured to control the liquid pattern applied onto the receiving roll to control the coating volume.

Embodiment 21 is a method comprising:
applying a liquid material onto a receiving roll to form a liquid pattern; and
transferring at least a portion of the liquid material in the liquid pattern from the receiving roll onto a major surface of a web to form a substantially continuous coating,
wherein when applying the liquid material onto the first roll, a coating volume of the liquid material applied to the first roll is controlled to proportionally control a thickness for a given width of the continuous coating on the major surface of the web.

Embodiment 22 is the method of embodiment 21, wherein transferring the liquid material comprises directly transferring at least a portion of the liquid material from the receiving roll onto the major surface of the web.

Embodiment 23 is the method of embodiment 21 or 22, wherein transferring the liquid material further comprises transferring the liquid material from the receiving roll onto a web transfer roll, and from the web transfer roll to the major surface of the web.

Embodiment 24 is the method of any one of embodiments 21-23, wherein transferring the liquid material further comprises transferring the liquid material from the receiving roll onto one or more intermediate transfer rolls and then onto a web transfer roll and then transferring the liquid material from the web transfer roll onto the major surface of the web.

Embodiment 25 is a coating system comprising:
a receiving roll;
an applicator configured to apply a liquid material onto the receiving roll to form a liquid pattern; and
a web directly or indirectly engaging with the receiving roll such that at least a portion of the liquid material in the liquid pattern from the receiving roll is transferred onto a major surface of the web to form a substantially continuous coating,
wherein when applying the liquid material onto the first roll, the applicator is configured to control a coating volume of the liquid material applied to the receiving roll to proportionally control a thickness for a given width of the continuous coating on the major surface of the web.

Embodiment 26 is the coating system of embodiment 25, further comprising a web transfer roll engaging with the receiving roll, wherein the liquid material in the liquid pattern is transferred from the receiving roll onto the web transfer roll, and from the web transfer roll to the major surface of the web.

Embodiment 27 is the coating system of embodiment 26, further comprising one or more intermediate rolls between the receiving roll and the web transfer roll, transferring the liquid material from the receiving roll onto one or more intermediate transfer rolls and then onto the web transfer roll.

The operation of the present disclosure will be further described with regard to the following detailed examples. These examples are offered to further illustrate the various specific and preferred embodiments and techniques. It should be understood, however, that many variations and modifications may be made while remaining within the scope of the present disclosure.

### EXAMPLES

These Examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

### I. Printing Systems

All examples were coated using a flexographic printing deck manufactured by Retroflex Inc. (Wrightstown, WI, USA) on a roll-to-roll webline. The flexographic printing deck was set up in direct (FIG. 1A) or offset (FIG. 2) mode. The following process conditions and materials were used to print all examples:
(1) Pattern Applicator: Konica Minolta KM1024i MHE (13 pL drop volume) piezoelectric inkjet printhead available from Industrial Inkjet USA (Golden, CO, USA).
(2) Roll #1 A: A gravure roll fabricated by Interflex Laser Engravers (Spartanburg, S.C., USA), with an approximate volume factor of 0.45 BCM/in² (1 BCM/in² is equal to 1.55 μm³/μm²)
(3) Roll #1 B: A polished steel roll with a roughness specification (Ra=1 μin).
(4) Roll #1 C: A nominally 0.60 BCM/in² gravure roll fabricated by Interflex Laser Engravers (Spartanburg, S.C., USA), roughness specifications (Ra-8 μin, Rz=65 μin, Rp=22 μin). One μin is equal to 25.4 nm.
(5) Roll #2 (used ONLY in Offset configuration): EPDM rubber from Luminite, 70 Shore A hardness, roughness specifications (Ra=21 μin, Rz=214 μin, Rp=144 pin).
(6) Roll #3/Backup Roll: Steel roll, 10 inch diameter. One inch is equal to 2.54 cm.
(7) Liquid Material A: LTM Diacrylate coating material available from 3M Co. (St. Paul, MN, USA).
(8) Liquid Material B: Stearyl acrylate/SR257 coating material available from Arkema Inc. (King of Prussia, PA, USA)
(9) Web: 3-mil PET film available from 3M Co. (St. Paul, MN, USA). One mil is equal to 25.4 micrometer.

The web was loaded onto the flexographic printing line and put under 1 pound per linear inch of tension. The line was run at about 10 feet per minute to transport the web through the flexographic printing deck. A dot array of liquid material was applied to the Roll #1 using the pattern applicator with the patterned applicator gapped to the receiving roll surface set at 2 mm. The coated liquid material exiting the flexographic printing deck was cured using a UV cure oven available from Xeric Web Drying Systems (Neenah, WI, USA). The cured coating of liquid material was subsequently wound up into a roll.

### II. Coating Results

1. Thickness versus Roll Speed Ratio

The flexographic printing deck was run in offset configuration (FIG. 2). Coating thickness was shown to proportionally change with the input rate of liquid in Tables 1 and 2.

The input rate of liquid was varied by changing the speed ratio of Roll #1 (210 in FIG. 2.) to the Roll #2 (240 in FIG. 2) when the drop spacing was referenced to the speed of Roll #1 in Table 1.

TABLE 1

| | | | | | | Coating |
|---|---|---|---|---|---|---|
| | | Mode | | CW Dot | DW Dot | Thick- |
| Sample | Roll | (Fwd or | Speed Ratio | Spacing | Spacing | ness |
| # | #1 | Rev) | Roll#1:Roll#2 | (μm) | (μm) | (Å) |
| 1 | A | Rev | 0.5 | 70.5 | 282 | 1917 |
| 2 | A | Rev | 0.75 | 70.5 | 282 | 2943 |
| 3 | A | Rev | 1 | 70.5 | 282 | 3800 |
| 4 | A | Rev | 1.25 | 70.5 | 282 | 4527 |
| 5 | A | Rev | 1.5 | 70.5 | 282 | 5107 |
| 6 | A | Rev | 0.1 | 70.5 | 282 | 504 |
| 7 | A | Rev | 0.25 | 70.5 | 282 | 908 |

Alternatively, the input rate of liquid was held constant while changing the roll speed ratio of Roll #1 to Roll #2 when the drop spacing was referenced to the speed of Roll #2 in Table 2. Note that Roll #2 and Roll #3 (230 in FIG. 2) were run in Forward mode with a roll speed ratio of 1 for Samples 1 to 10.

TABLE 2

| | | | | | | Coating |
|---|---|---|---|---|---|---|
| | | Mode | | CW Dot | DW Dot | Thick- |
| Sample | Roll | (Fwd or | Speed Ratio | Spacing | Spacing | ness |
| # | #1 | Rev) | Roll #1:Roll #2 | (μm) | (μm) | (Å) |
| 8 | A | Rev | 0.5 | 70.5 | 282 | 3923 |
| 9 | A | Rev | 1 | 70.5 | 282 | 3866 |
| 10 | A | Rev | 2 | 70.5 | 282 | 3676 |

Samples 1 to 10 were coated with Liquid Material A. Coating thickness was measured using X-ray fluorescence.

2. Thickness versus Drop Spacing

The flexographic printing deck was run in offset configuration (FIG. 2). Coating thickness was shown to change proportionally with the input rate of liquid varied by changing down-web (DW) drop spacing in Table 3. Note that increasing the DW dot spacing from 282 micrometers to 352 micrometers is a reduction of the input rate of liquid by a factor of 0.8. Table 3 also summarizes thickness versus volume of input liquid where the volume of input liquid is changed by roll speed ratio between Roll #1 (210) and Roll #2 (240) where the drop spacing is referenced to Roll #1.

TABLE 3

| | | | | | | Coating |
|---|---|---|---|---|---|---|
| | | Mode | | CW Dot | DW Dot | Thick- |
| Sample | Roll | (Fwd or | Speed Ratio | Spacing | Spacing | ness |
| # | #1 | Rev) | Roll#1:Roll#2 | (μm) | (μm) | (Å) |
| 11 | B | Rev | 0.25 | 70.5 | 282 | 1091 |
| 12 | B | Rev | 0.5 | 70.5 | 282 | 2415 |
| 13 | B | Rev | 1 | 70.5 | 282 | 4193 |
| 14 | B | Rev | 0.25 | 70.5 | 352 | 913 |
| 15 | B | Rev | 0.5 | 70.5 | 352 | 1764 |
| 16 | B | Rev | 1 | 70.5 | 352 | 3329 |

### 3. Patterned Array to Continuous Coating

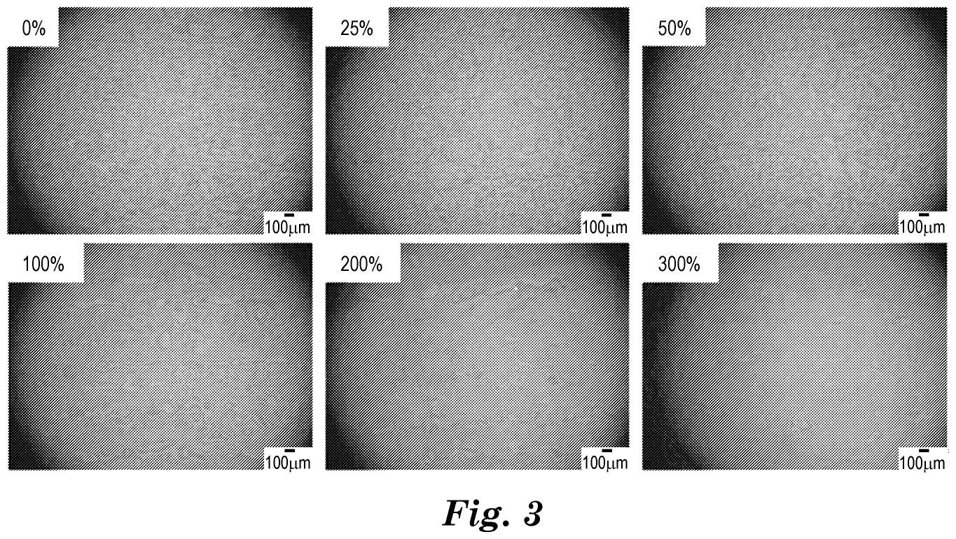

The flexographic printing deck was run in direct configuration (FIG. 1A) and reverse mode at various roll speed ratios between Roll #1 (110) and Roll #3 (130) from +0% to +300% with the drop spacing referenced to Roll #1. A 282 μm×282 μm drop array of Liquid Material B was patterned onto Roll #1 A. Note that the 282 μm drop spacing is much greater than the diameter of the patterned about 13 pL drops such that the applied pattern is discrete. A continuous coating was achieved in all cases as shown by optical microscope images of the coated polyester in FIG. 3. Continuous coatings were also achieved with Roll #1 B.

### 4. Roll Surface Finish Versus Uniformity

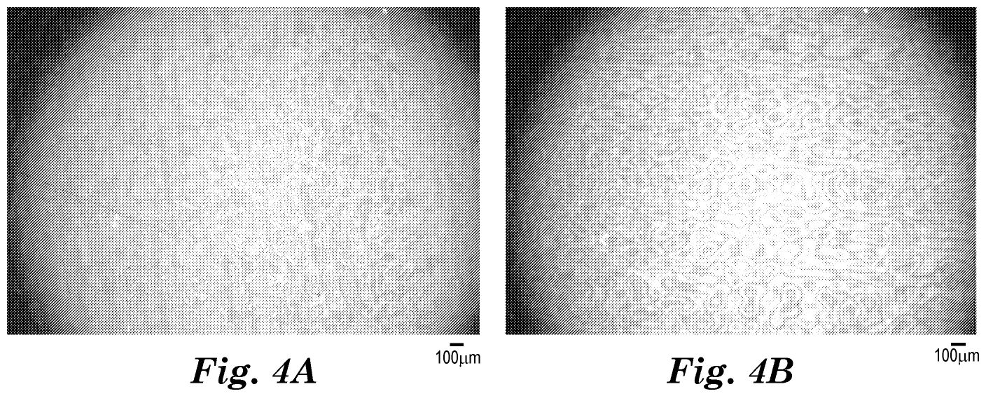

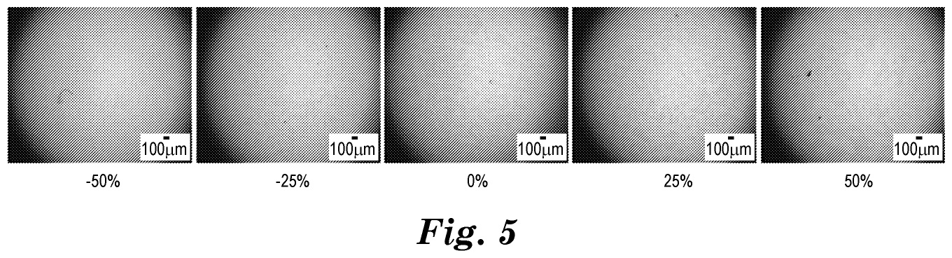

The flexographic printing deck was run in direct configuration and reverse mode with all other conditions equal for comparison. FIGS. 4A-B are optical microscope images of the coated polyester using Roll #1A and Roll #1C. A 282 μm×282 μm drop array of Liquid Material B was patterned onto Roll #1 C (FIG. 4A) and separately onto Roll #1A (FIG. 4B). A discontinuous coating and residual drop array pattern were observed for the sample made with Roll #1 C. A continuous coating was observed for the sample made with Roll #1 A.

### 5. Roll Speed Ratio Versus Uniformity

The flexographic printing deck was run in offset configuration (FIG. 1A) and reverse mode at various roll speed ratios between Roll #1 (210) and Roll #2 (240) from +0% to +300% with the drop spacing referenced to Roll #1. A 141 μm×141 μm drop spacing was applied to Roll #1 A. FIG. 5 is optical microscope images of Liquid Material A coated on polyester. An improvement in coating uniformity based on the visual iridescent pattern was shown as the roll speed ratio varied from +50% (150% of line speed) to −50% (50% of line speed).

Reference throughout this specification to “one embodiment,” “certain embodiments,” “one or more embodiments” or “an embodiment,” whether or not including the term “exemplary” preceding the term “embodiment,” means that a particular feature, structure, material, or characteristic described in connection with the embodiment is included in at least one embodiment of the certain exemplary embodiments of the present disclosure. Thus, the appearances of the phrases such as “in one or more embodiments,” “in certain embodiments,” “in one embodiment” or “in an embodiment” in various places throughout this specification are not necessarily referring to the same embodiment of the certain exemplary embodiments of the present disclosure. Furthermore, the particular features, structures, materials, or characteristics may be combined in any suitable manner in one or more embodiments.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. In particular, as used herein, the recitation of numerical ranges by endpoints is intended to include all numbers subsumed within that range (e.g., 1 to 5 includes 1, 1.5, 2, 2.75, 3, 3.80, 4, and 5). In addition, all numbers used herein are assumed to be modified by the term “about.”

Furthermore, all publications and patents referenced herein are incorporated by reference in their entirety to the same extent as if each individual publication or patent was specifically and individually indicated to be incorporated by reference. Various exemplary embodiments have been described. These and other embodiments are within the scope of the following claims.

1. A method comprising:
premetering a liquid material onto a receiving roll to form a discontinuous liquid pattern; and
transferring at least a portion of the liquid material in the discontinuous liquid pattern from the receiving roll onto a major surface of a web to form a continuous coating;
wherein premetering the liquid material onto the receiving roll comprises applying a coating volume of the liquid material to the receiving roll to proportionally control a thickness for a given width of the continuous coating on the major surface of the web.

2. The method of claim 1, wherein transferring at least a portion of the liquid material in the discontinuous liquid pattern from the receiving roll onto a major surface of a web comprises transferring the liquid material from the receiving roll directly onto the major surface of the web to form the continuous coating such that the receiving roll is a web transfer roll.

3. The method of claim 1, wherein transferring at least a portion of the liquid material in the discontinuous liquid pattern from the receiving roll onto a major surface of a web comprises transferring at least a portion of the liquid material in the discontinuous liquid pattern from the receiving roll onto a web transfer roll and transferring at least a portion of the liquid material from the web transfer roll directly onto the major surface of the web to form the continuous coating.

4. The method of claim 3, wherein the at least a portion of the liquid material in the discontinuous liquid pattern is transferred from the receiving roll onto the web transfer roll via one or more intermediate transfer rolls.

5. The method of claim 3, further comprising applying an impression force to press the major surface of the web against the web transfer roll.

6. The method of claim 5, wherein applying the impression force comprises forming a nip between a backup roll and the web transfer roll and pressing the major surface of the web against the web transfer roll via a backup roll.

7. The method of claim 5, wherein applying the impression force further comprises wrapping a free span of the web around the web transfer roll such that the major surface of the web is pressed against the web transfer roll.

8. The method of claim 1, further comprising controlling the coating volume of the liquid material applied to the receiving roll such that the continuous coating has a coating thickness in a range from 10 nanometers to 5 micrometers.

9. The method of claim 1, wherein controlling the coating volume of the liquid material further comprises controlling the liquid pattern on the receiving roll.

10. The method of claim 1, wherein applying the liquid material onto the receiving roll further comprises inkjet printing the liquid material to form the discontinuous liquid pattern.

11. The method of claim 1, wherein the discontinuous liquid pattern comprises at least one of a regular or irregular pattern of dots, discontinuous lines, grids, or geometric shapes.

12. The method of claim 1, wherein applying the liquid material onto the receiving roll further comprises at least one of flexographic printing, or gravure printing.

13. A coating system comprising:
a receiving roll;
an applicator configured to premeter a liquid material onto the receiving roll to form a discontinuous liquid pattern; and
a web engaging with the receiving roll such that at least a portion of the liquid material in the discontinuous liquid pattern from the receiving roll is directly transferred onto a major surface of the web to form a substantially continuous coating,
wherein when premetering the liquid material onto the receiving roll, the applicator is configured to control a coating volume of the liquid material applied to the receiving roll to proportionally control a thickness for a given width of the continuous coating on the major surface of the web.

14. A coating system comprising:
a receiving roll;
an applicator configured to premeter a liquid material onto the receiving roll to form a discontinuous liquid pattern;
a web transfer roll, wherein the web transfer roll directly engages with the receiving roll to receive at least a portion of the liquid material from the receiving roll; and
a web engaging with the web transfer roll such that at least a portion of the liquid material on the web transfer roll is transferred onto a major surface of the web to form a substantially continuous coating,
wherein when premetering the liquid material onto the receiving roll, the applicator is configured to control a coating volume of the liquid material applied to the receiving roll to proportionally control a thickness for a given width of the continuous coating on the web transfer roll and the major surface of the web.

15. The coating system of claim 13, wherein the applicator includes an inkjet printer.

16. A coating system comprising:
a receiving roll;
an applicator configured to premeter a liquid material onto the receiving roll to form a discontinuous liquid pattern;
a web transfer roll, and one or more intermediate rolls between the receiving roll and the web transfer roll, wherein the web transfer roll indirectly engages with the receiving roll via the one or more intermediate rolls, to receive at least a portion of the liquid material from the receiving roll; and
a web engaging with the web transfer roll such that at least a portion of the liquid material on the web transfer roll is transferred onto a major surface of the web to form a substantially continuous coating,
wherein when premetering the liquid material onto the receiving roll, the applicator is configured to control a coating volume of the liquid material applied to the receiving roll to proportionally control a thickness for a given width of the continuous coating on the web transfer roll and the major surface of the web.

17. The coating system of claim 14, wherein the applicator includes an inkjet printer.

18. The coating system of claim 16, wherein the applicator includes an inkjet printer.

19. The method of claim 1, wherein the liquid material in the discontinuous liquid pattern is discontinuous in both a cross-web direction and a down-web direction.
